(19) United States
(12) Patent Application Publication
(10) Pub. No.: US 2013/0272658 A1
(43) Pub. Date: Oct. 17, 2013

(54) MULTI-MODE MULTI-FIBER CONNECTION WITH EXPANDED BEAM

(71) Applicant: TYCO ELECTRONICS NEDERLAND BV, 'S-Hertogenbosch (NL)

(72) Inventors: Sander Johannes Floris, Best (NL); Ton Bolhaar, Ophemert (NL); Jan Wiilem Rietveld, Benschop (NL)

(21) Appl. No.: 13/826,235

(22) Filed: Mar. 14, 2013

Related U.S. Application Data
(60) Provisional application No. 61/622,794, filed on Apr. 11, 2012.

(51) Int. Cl. G02B 6/38

(52) U.S. Cl. CPC G02B 6/38
USPC 385/60; 385/58; 29/428; 29/469

(57) ABSTRACT

A method and system using GRIN fibers with a large core radius (such as twice that of the optical fibers which the GRIN fibers are used to interconnect) to expand incident beam are disclosed. In certain examples, the GRIN fibers expand the incident beams to near-collimation. In certain examples, the beam expansion reduces the connection's sensitivity (i.e., power attenuation) to lateral displacement between the optical fibers at the cost of increased sensitivity to angular misalignment between the fibers. With certain fiber connection hardware that provides precision angular alignment, beam expansion provides improved connection performance. In certain examples, a multi-fiber connector module (such as MPO), with MT-style ferrules, is used to interconnect multiple fiber pairs, each with GRIN fiber endings. In certain examples, the near-collimation of the incident beams allows efficient transmission between fibers without the need for physical contact between the fibers.

### CROSS-REFERENCE TO RELATED APPLICATIONS

The present application claims the benefit of U.S. Provisional Application No. 61/622,794, filed Apr. 11, 2012, which is incorporated herein by reference.

### INTRODUCTION

This disclosure relates generally to interconnections between optical fibers and more specifically relates to high-density multi-fiber connectors for multi-mode optical fibers.

Optical fibers find a wide range of applications, from high-speed data communication systems to surgical devices employing high-power lasers. Optical connectors are often needed in fiber-optical systems to serve such purposes as splicing optical cables and attaching a variety of laser tools to optical cables. There is a continuing need to provide high-efficiency, multi-fiber, optical connectors to minimize power loss in optical transmission and facilitate convenient connection of multiple fiber pairs.

The present disclosure discloses a multi-fiber connector for multi-mode fibers. The connector employs graded-index (GRIN) fibers to expand the diameter of the beams from the transmitting multi-mode fibers and refocus the beams into the receiving fibers.

### SUMMARY

This disclosure presents using GRIN fibers with a large core radius (such as twice that of the optical fibers which the GRIN fibers are used to interconnect) to expand incident beam. In certain examples, the GRIN fibers expand the incident beams to near-collimation. The beam expansion reduces the connection's sensitivity (i.e., power attenuation) to lateral displacement between the optical fibers at the cost of increased sensitivity to angular misalignment between the fibers. However, with certain fiber connection hardware, angular alignment is more easily controlled, making having a higher sensitivity to angular misalignment a more preferable choice to having a higher sensitivity to lateral displacement.

In certain examples, a multi-fiber connector module (such as MPO), with MT-style ferrules, are used to interconnect multiple fiber pairs, each with GRIN fiber endings as described above. In certain examples, the near-collimation of the incident beams allows efficient transmission between fibers without the need for physical contact between the fibers. In further examples, antireflection coating can be applied to the GRIN fiber interface to further increase the coupling efficiency.

### BRIEF DESCRIPTION OF THE DRAWINGS

FIG. 1 schematically shows beam expansion in a GRIN fiber terminated interconnection system.

FIG. 2 shows the parabolic refractive index profiles for both the standard fiber and GRIN fiber at a wavelength of 850 nm.

FIG. 3 schematically shows beam expansion in a GRIN fiber terminated interconnection system.

FIG. 4 shows the sensitivity to lateral misalignment in terms of attenuation for fiber interfaces without and with expanded beam using intermediate GRIN fibers.

FIG. 5 schematically shows the effect of angular misalignment between the GRIN fiber pair.

FIG. 6 schematically shows quantified angular misalignment between the GRIN fiber pair.

### DETAILED DESCRIPTION

GRIN fiber lens has typically been used to expand beams from single-mode fibers, the core diameter of which is typically on the order of a few micrometers, to make high efficiency long haul connections. Beam expansion greatly reduces the energy density at the GRIN-GRIN interface and thus greatly reduces the sensitivity to misalignment between the fibers. In contrast, multi-mode fibers typically have large diameters (e.g., 50 μm). As a consequence, significant beneficial effect of beam expansion for optical coupling between multi-mode optical fibers may not be immediately apparent. According to certain aspects of the present disclosure, GRIN fiber with a large core can be used to achieve significant reduction in energy density, thereby reducing sensitivity to such factors as presence of dust particles and lateral displacement. Furthermore, by substantially collimating optical beams using GRIN fibers, end-to-end physical contact between fibers is not required. This characteristic can have a significant impact on the durability of multi-fiber connectors, as physical contacts between multiple pairs of optical fibers can give rise to significant stress on the connector structure and negatively impact the durability of the connectors.

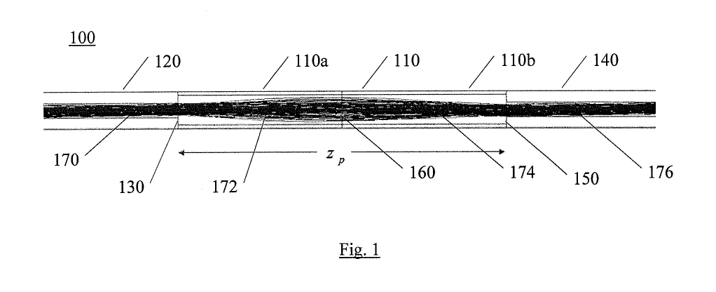

A GRIN fiber system 100 for expanded beam connection between multi-mode optical fibers is schematically shown in FIG. 1. In this configuration, a GRIN lens 110, which can include two separate GRIN fibers 110a and 110b, with an interface 160, optically connects two multi-mode optical fibers 120 and 140, at interfaces 130 and 150, respectively. Each of the GRIN fibers 110a and 110b in this example is a ¼-pitch GRIN fiber. The GRIN lens and optical fibers 120 and 140 in this example are solid cylindrical shaped, each having an optical axis aligned along the z-axis. The GRIN lens 110 in this example is made up of two optical fiber segments 110a and 110b of the same diameter as the optical fibers 120 and 140 to which the segments 110a and 110b, respectively, are connected, but may be of other cross-sectional dimensions. In addition, the interface 160 between the two halves 110a and 110b can be a contact interface between the two halves but may also be an air gap or vacuum gap. The total length, zₚ, of the lens 110 is the sum of the lengths of the GRIN fiber segments 110a and 110b.

As further illustrated in FIG. 1, the optical beam 170 from the multi-mode fiber 120 is formed into an expanded beam 172 in the GRIN fiber segment 110a. At the exit plane (interface 160) of the GRIN fiber segment 110a, the beam 172 is substantially collimated. Upon entering the GRIN fiber segment 110b, the substantially collimated beam 174 is refocused and launched into another multi-mode fiber 140 as a guided beam 176.

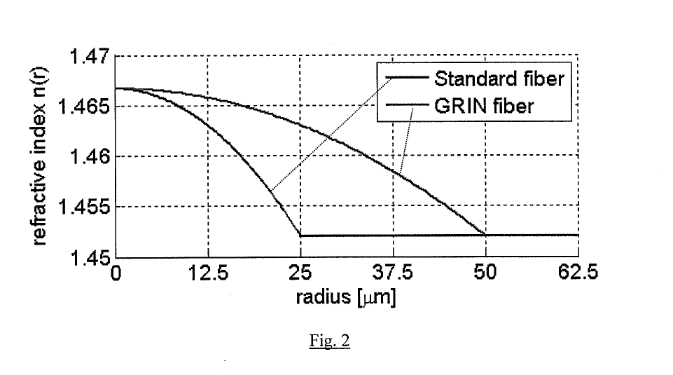

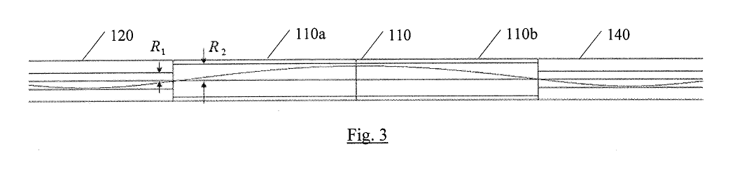

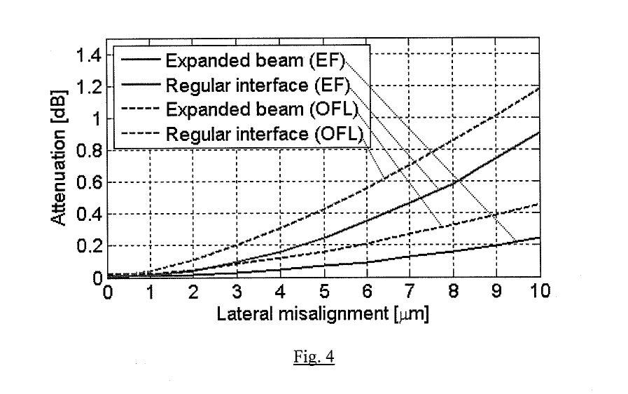

As shown in FIGS. 2 and 3, in an exemplary configuration according to the present disclosure, the GRIN fibers 110a and 110b has a core radius, R₂, that is greater than the core radius, R₁, of the multi-mode optical fibers (also called “standard fibers”) 120 and 140. As shown in FIG. 2, in this particular example, R₂ is about twice R₁. The GRIN fiber core in this case has the same contrast (i.e., the difference between the refractive index, n_{co}, at the center of the core and the refractive index, n_{cl}, of the cladding). The energy density is reduced by a factor of (R₂/R₁)²=4. The sensitivity to lateral misalignment is significantly reduced, as shown in FIG. 4, in which the plots of attenuation as a function of later misalignment, with the assumptions of an intrinsic attenuation 0.02 dB, perfect alignment of GRIN-to-fiber splices. The plots are for overfilled launch (OFL) and restricted launch known as Encircled Flux (EF).

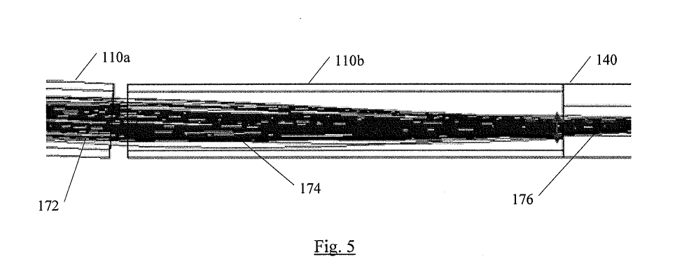

While an expanded-beam interface reduces the sensitivity to the lateral misalignment, it increases the sensitivity to angular misalignment. As FIG. 5 schematically illustrates, the displacement of the beam at the GRIN-fiber interface can be directly related to the angular misalignment at the GRIN-GRIN interface.

From geometrical optics, every ray can be characterized by the formula:

β̅=n(r)cos(θ),

where, β̅ is the propagation coefficient, n(r) is the refractive index at distance r from the center of the core, and θ is the angle relative to the optical axis.

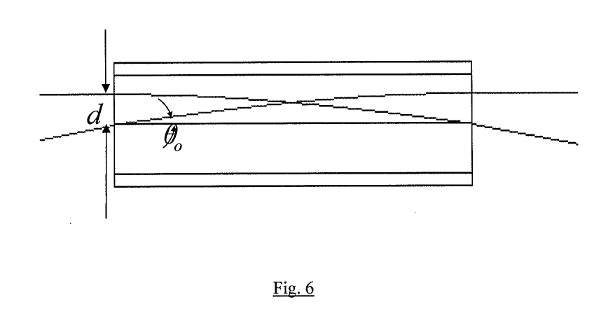

Consider a ray and its ‘reciprocal’, one can derive an expression for the misalignment, d, as function of tilt angle θ₀ (see FIG. 6) by imposing the condition:

β̅₁= β̅₂=n(d)=n_{core} cos θₒ .

Thus, for a parabolic refractive index profile as described above, one obtains:

$$d = \frac{{n}_{core} R sin {θ}_{o}}{\sqrt{{n}_{core}^{2} - {n}_{cladding}^{2}}} .$$

where n_{core} and n_{cladding} are, respectively, the refractive indexes at the center of the core and in the cladding.

Therefore, to reduce the sensitivity to angular misalignment, several factors may be changed, including (a) reducing R, (b) increasing the contrast and (c) reducing n_{core}. However, the beam expansion has a similar dependency on these factors. There is thus a trade-off between minimizing sensitivity to lateral misalignment and minimizing sensitivity to angular misalignment. In designing the GRIN fiber, one can find an optimum for the beam expansion factor that is constrained by tilt angle, tolerance on lens length and splice quality. In certain applications, because angular alignment is more easily controlled, it can be useful to increase the beam expansion at the cost of increased sensitivity to angular misalignment.

The GRIN fiber configuration described above can be used advantageously in multi-fiber connectors for multi-mode optical fibers. In certain aspects of the present disclosure, a multi-fiber connector module (such as MPO), with MT-style ferrules, are used to interconnect multiple fiber pairs, each with a pair of GRIN fiber endings as described above. MT-style ferrules generally provide very close tolerance in angular alignment and can thus be exploited to increase the beam expansion.

An advantage of using the GRIN fibers 110a and 110b as described above, in addition to obtaining a reduced energy density and thus reduced sensitivity to dust and lateral misalignment, is the substantial collimation of the beam 172 at the exit of the GRIN fiber 110a. The collimation affords low-loss transmission of optical beams from the GRIN fiber 110a into the GRIN fiber 110b without the two GRIN fibers being in physical contact. That is, there can be an air gap between the two GRIN fibers. Such a contact-less interface reduces stress on the physical structure of the connector assembly that supports the multi-mode fibers and GRIN fibers, especially multi-fiber connector assemblies, in which the total amount of stress due to the physical contacts of all fibers in the connector can be significant.

As a further enhancement to optical coupling efficiency, in certain examples, an antireflection coating is applied to the GRIN fiber interface to reduce attenuation and back reflection.

Thus, a GRIN fiber expanded-beam, multi-fiber connection for multi-mode optical fibers has been achieved according to the present disclosure. Because many embodiments of the invention can be made without departing from the spirit and scope of the invention, the invention resides in the claims hereinafter appended.

1. An optical fiber connector, comprising:
a plurality of optical fiber assemblies, each comprising a multi-mode optical fiber defining an optical axis and a grade-index (GRIN) fiber defining another optical axis and connected to the multi-mode optical fiber with the optical axes of the multi-mode fiber and GRIN fiber substantially aligned with each other, the multi-mode optical fiber having a core with a cross-sectional dimension, the GRIN fiber having a core with a cross-sectional dimension greater than the cross-sectional dimension of the multi-mode fiber; and
a support holding the plurality of optical fiber assemblies.

2. The optical fiber connector of claim 1, wherein the GRIN fiber in each optical fiber assembly is adapted to substantially collimate optical beams received from the multi-mode optical fiber to which the GRIN fiber is connected.

3. The optical fiber connector of claim 1, wherein the GRIN fiber has a core with a cross-sectional dimension at least twice as large as the cross-sectional dimension of the multi-mode fiber.

4. The optical fiber connector of claim 2, wherein the GRIN fiber has a core with a cross-sectional dimension at least twice as large as the cross-sectional dimension of the multi-mode fiber.

5. The optical fiber connector of claim 1, wherein the support comprises a ferrule having a plurality of channels, each of which adapted to accommodate a respective one of the optical fiber assemblies.

6. The optical fiber connector of claim 5, wherein the ferrule comprises an MT-style ferrule.

7. The optical fiber connector of claim 1, wherein the GRIN fiber in each of the optical fiber assemblies define two end surfaces disposed apart along the optical axis of the GRIN fiber, one of the two end surfaces being optically connected to the multi-mode fiber in the assembly, the connector further comprising an antireflection coating on the other of the end surfaces.

8. An optical fiber connection system, comprising two optical fiber connectors of any of claim 1, the two connectors adapted to form mating engagement with each other, wherein the optical fiber assemblies in each of the two connectors are disposed to be axially opposing the respective optical fiber assemblies in the other of the two connections, with the GRIN fibers in each pair of the opposing optical fiber assemblies disposed adjacent each other, when the two connectors form mating engagement with each other.

9. The optical fiber connection system of claim 8, wherein the GRIN fibers in each pair of the opposing optical fiber assemblies define a gap therebetween when the two connectors form mating engagement with each other.

10. A method for facilitating optical coupling of optical fibers, the method comprising:
forming a first plurality of optical fiber assemblies, each comprising a multi-mode optical fiber defining an optical axis and a grade-index (GRIN) fiber defining another optical axis and connected to the multi-mode optical fiber with the optical axes of the multi-mode fiber and GRIN fiber substantially aligned with each other, the multi-mode optical fiber having a core with a cross-sectional dimension, the GRIN fiber having a core with a cross-sectional dimension greater than the cross-sectional dimension of the multi-mode fiber; and
securing the first plurality of optical fiber assemblies to, and restricting angular motion of each of the first plurality of optical fiber assemblies relative to, a first holder.

11. The method of claim 10, further comprising:
forming a second plurality of optical fiber assemblies, each comprising a multi-mode optical fiber defining an optical axis and a grade-index (GRIN) fiber defining another optical axis and connected to the multi-mode optical fiber with the optical axes of the multi-mode fiber and GRIN fiber substantially aligned with each other, the multi-mode optical fiber having a core with a cross-sectional dimension, the GRIN fiber having a core with a cross-sectional dimension greater than the cross-sectional dimension of the multi-mode fiber;
securing the second plurality of optical fiber assemblies to, and restricting angular motion of each of the second plurality of optical fiber assemblies relative to, a second holder; and
securing the first holder to the second holder to fixedly dispose the first plurality of optical fiber assemblies relative to the second plurality of optical fiber assemblies, with the GRIN fiber in each of the first plurality of optical fiber assemblies and the GRIN fiber in a respective one of the second plurality of optical fiber assemblies disposed adjacent to each other and with the optical axes of the two adjacent GRIN fibers substantially aligned with each other.

12. The method of claim 11, further comprising separating the each pair of adjacent GRIN fibers by a fixed gap.
